(19) United States
(12) Patent Application Publication
(10) Pub. No.: US 2013/0148292 A1
(43) Pub. Date: Jun. 13, 2013

(54) SERVER SYSTEM WITH FAN SPEED CONTROL

(71) Applicant: CHIH-CHUNG SHIH, Tu-Cheng (TW)

(72) Inventor: CHIH-CHUNG SHIH, Tu-Cheng (TW)

(73) Assignee: HON HAI PRECISION INDUSTRY CO., LTD., Tu-Cheng (TW)

(21) Appl. No.: 13/587,941

(22) Filed: Aug. 17, 2012

(30) Foreign Application Priority Data
Dec. 13, 2011 (TW) 100145910

(51) Int. Cl. G06F 1/20

(52) U.S. Cl. 361/679.48

(57) ABSTRACT

A server system includes a server cabinet, several servers accommodated in the server cabinet, several fan groups coupled to a rear side of the server cabinet, and several fan control boards. The servers each include an intelligent platform management interface. Each fan group includes a row of fans to provide a horizontal airflow to cool several of the servers. The fan control boards each include several intelligent platform management interfaces each connected to the intelligent platform management interface via an intelligent platform management bus, thereby allowing the servers sending a message to a corresponding one fan control board. When the fan control board receives one or more messages from the servers, the fan control board is capable of transmitting an electrical signal corresponding to the one or more messages for controlling a rotation speed of a corresponding one fan group.

### RELATED APPLICATIONS

Related subject matter is disclosed in a co-pending U.S. patent application with an Attorney Docket Number of US41402 and a title of SERVER SYSTEM WITH FAN SPEED CONTROL, filed on 2011-12-27, which has the same assignee as the current application.

### BACKGROUND

1. Technical Field

The present disclosure relates to a server system capable of controlling fan rotation speeds of the fans.

2. Description of Related Art

Server systems are commonly used to process and store data or information in networks. The server system includes a server cabinet and a number of servers accommodated in the server cabinet. A number of fans are arranged in the back of the server cabinet for cooling the servers during operation. Although server systems satisfy basic requirements, a new type of server system is still needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a back view of a server system in accordance with an exemplary embodiment.

FIG. 2 is a block diagram of the server system of FIG. 1.

### DETAILED DESCRIPTION

Embodiments of the present disclosure are now described in detail, with reference to the accompanying drawings.

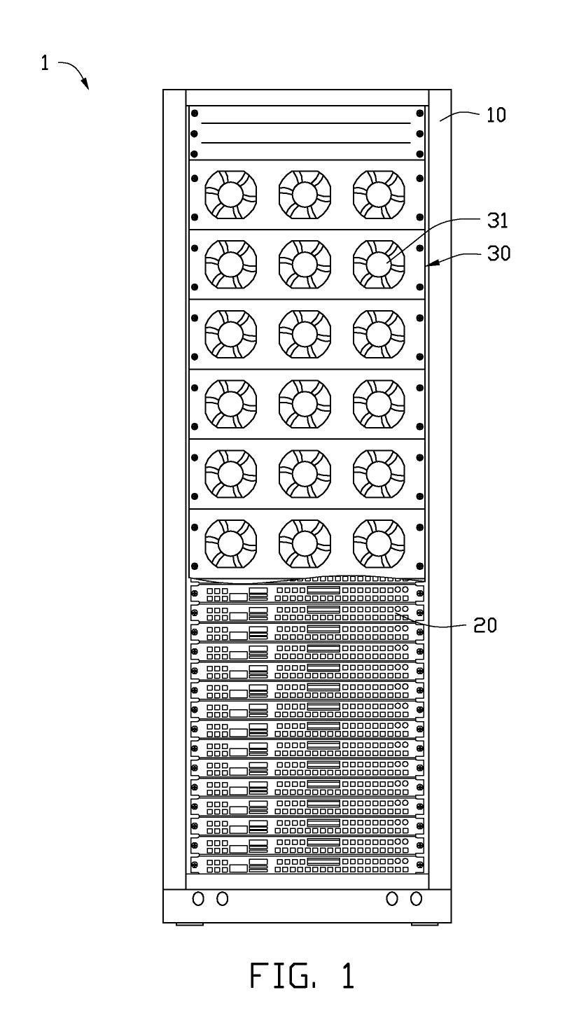

FIG. 1 illustrates a back view of a server system 1 according to an exemplary embodiment. The server system 1 includes a rectangular server cabinet 10 with two parallel racks 11, a number of servers 20 located between the two racks 11, and a number of fan groups 30 coupled to a rear side of the server cabinet 10. In the embodiment, the length of the rack 11 is about 42 U (1 U =44.45 mm) or 48 U in height and can accommodate 42 or 48 servers 2 at most.

The fan groups 30 each include a row of parallel fans 31 to provide a horizontal airflow for cooling the corresponding servers 20 which is substantially aligned with the fans 31. Each fan group 30 may include three fans 31 arranged in a line, and the size of each fan 31 may be 92 mm*92 mm or 120 mm* 120 mm. In the embodiment, the fans 31 of each fan group 30 provide a horizontal airflow to cool three, four or five servers 20 which is substantially aligned to the fan group 30.

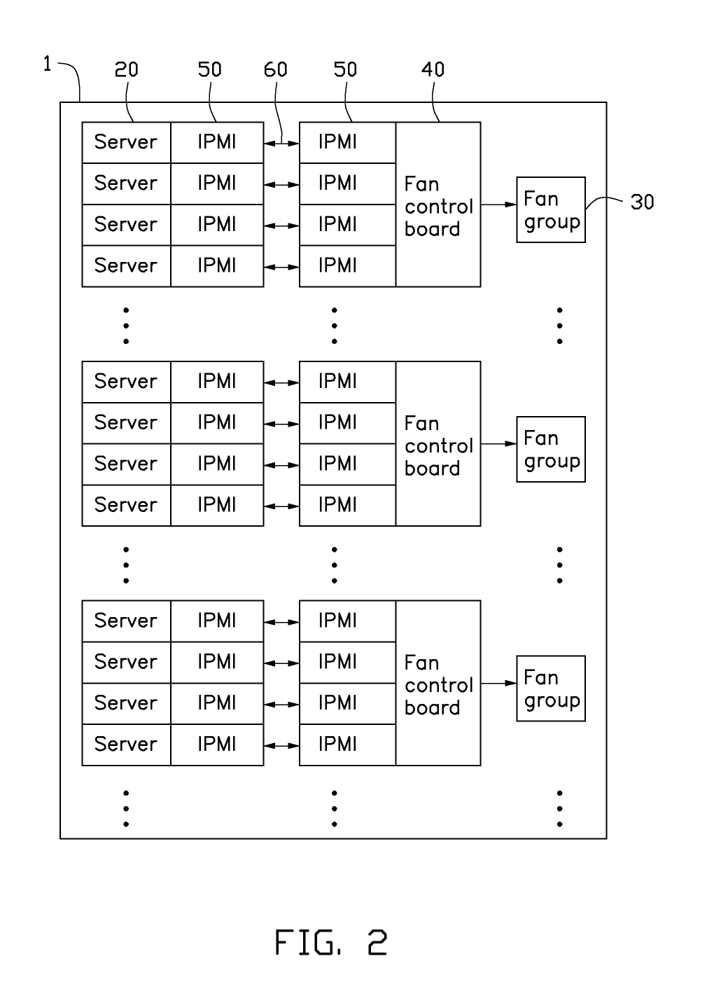

Referring also to FIG. 2, the server system 1 further includes a number of fan control boards 40 and a number of intelligent platform management buses (IPMB) 60. The servers 20 each include an intelligent platform management interface (IPMI) 50, and the fan control boards 40 each include a number of intelligent platform management interfaces 50. The intelligent platform management interface 50 of the fan control board 40 is connected to the intelligent platform management interface 50 of the server 20 via an intelligent platform management bus 60. Thus, the servers 20 can send a message to a corresponding fan control board 40.

Each fan control board 40 is further connected to a fan group 30. When the fan control board 40 receives one or more messages from the servers 20, the fan control board 40 transmits an electrical signal corresponding to the one or more messages for controlling a rotation speed of a corresponding fan group 30. Thus, the corresponding fans 31 of the fan groups 30 can rotate at a corresponding speed to satisfy heat dissipation needs of the servers 2 and can be directly controlled by the control center 50. In an exemplary embodiment, the fan control boards 40 can be integrated on a circuit board.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A server system comprising:
a server cabinet;
a plurality of servers accommodated in the server cabinet, and each of the plurality of servers comprising an intelligent platform management interface;
a plurality of fan groups coupled to a rear side of the server cabinet, each fan group comprising a row of fans to provide a horizontal airflow to cool several of the plurality of servers; and
a plurality of fan control boards each comprising a plurality of intelligent platform management interfaces each connected to the intelligent platform management interface of one of the plurality of servers via an intelligent platform management bus, thereby allowing the plurality of servers sending one or more message to a corresponding one of the plurality of fan control boards;
wherein when each fan control board receives one or more messages from the plurality of servers, the fan control board is capable of transmitting an electrical signal corresponding to the one or more messages for controlling a rotation speed of a corresponding one of the plurality of fan groups.

2. The sever system as described in claim 1, wherein the server cabinet comprises two parallel racks, and the plurality of servers are located between the two racks.

3. The sever system as described in claim 2, wherein the racks is about 42 U in height and is able to accommodate 42 servers.

4. The sever system as described in claim 2, wherein the racks is about 48 U in height and is able to accommodate 48 servers.

5. The sever system as described in claim 1, wherein each fan group comprises three fans arranged in a line.

6. The sever system as described in claim 5, wherein the size of each fan is 92 mm*92 mm.

7. The sever system as described in claim 6, wherein the plurality of fans of each fan group provide a horizontal airflow to cool three, four or five of the plurality of servers which is substantially aligned to the fan group.

8. The sever system as described in claim 5, wherein the size of each fan is 120 mm* 120 mm.

9. The sever system as described in claim 8, wherein the plurality of fans of each fan group provide a horizontal airflow to cool three, four or five of the plurality of servers which is substantially aligned to the fan group.

10. The sever system as described in claim 1, wherein the plurality of fan control boards are integrated on a circuit board.
